(19) United States
(12) Patent Application Publication
(10) Pub. No.: US 2016/0304366 A1
(43) Pub. Date: Oct. 20, 2016

(54) METHODS FOR REMOVING CONTAMINANTS FROM AQUEOUS SYSTEMS

(71) Applicant: Kemira Oyj, Helsinki (FI)

(72) Inventors: Lucas Ryan Moore, Marietta, GA (US); Jean Robert Durand, Atlanta, GA (US)

(21) Appl. No.: 15/102,097

(22) PCT Filed: Dec. 17, 2014
(86) PCT No.: PCT/US14/70736

§ 371 Date: Jun. 6, 2016

Related U.S. Application Data
(60) Provisional application No. 61/917,498, filed on Dec. 18, 2013.

(51) Int. Cl. C02F 1/56

(52) U.S. Cl. CPC C02F 1/56; C02F 2101/106

(57) ABSTRACT

Methods for removing one or more contaminants from an aqueous stream comprising: adding a polymer comprising recurring units of one or more acrylamide monomers and recurring units of one or more monomers selected from hydroxyalkyl-methacrylates and allyloxyalkyldiols to the aqueous stream to form solidified contaminants; and separating the solidified contaminants from the aqueous stream are provided. The methods may be used for removing contaminants including zinc-, copper-, barium-, aluminum-, manganese-, cobalt-, and iron-based contaminants.

### CROSS-REFERENCE TO RELATED APPLICATIONS

The present disclosure claims priority to U.S. Provisional Application No. 61/917,498, filed Dec. 18, 2013.

### FIELD OF THE ART

The embodiments described herein relate to a method for removing contaminants from aqueous streams, such as waste waters and the like.

### BACKGROUND

Industrial waste waters commonly include a variety of contaminants, some of which require treatment or removal before the waste water can be discharged. For example, in certain industrial and mining processes, metals may be solubilized, sometimes in large quantities, generating waste water streams with metal contaminants. Metal contaminants can be toxic and may form poisonous water-soluble compounds. Exposure to such contaminants can negatively affect human and animal health, e.g., by causing liver and kidney damage from long-term exposure.

There are various commercially-available technologies for the removal of metal contaminants from an aqueous stream, including, for example: adsorption (e.g., adsorption on granular iron based media; adsorption on ion-exchange resins; and adsorption on activated alumina); chemical treatment (e.g., precipitation, cementation, coagulation, and flocculation methods); media filtration (filtering through sand, clay, titanium dioxide, or membranes such as osmosis or nanofiltration membranes); and biomediated removal. One method for removing metallic aqueous contamination is through the precipitation of the metal hydroxide that forms at elevated pH.

The description herein of certain advantages and disadvantages of known methods is not intended to limit the scope of the embodiments.

### BRIEF SUMMARY

Disclosed herein are methods for removing one or more contaminants from an aqueous stream comprising: adding a polymer comprising recurring units of one or more acrylamide monomers and recurring units of one or more monomers selected from hydroxyalkylmethacrylates allyloxyalkyldiols, allyloxyethanol, trimethylolpropane allyl ether, and 2-hydroxy ethyl acrylate to the aqueous stream to form solidified contaminants; and separating the solidified contaminants from the aqueous stream.

### DETAILED DESCRIPTION

Generally, the various methods described herein can be used to remove or reduce the amount of a metal or metalloid contaminant in an aqueous fluid. According to the exemplary methods, an aqueous stream containing a contaminant is treated with a polymer, resulting in a solid comprising the contaminant. The polymer comprises recurring units of one or more acrylamide monomers, and recurring units of one or more monomers selected from hydroxyalkylmethacrylates allyloxyalkyldiols, allyloxyethanol, trimethylolpropane allyl ether, and 2-hydroxy ethyl acrylate. After treatment, the solids can be separated from the aqueous stream, for example by gravity settling or mechanical separation.

### Polymers

As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. Unless otherwise specified, a polymer may be a “homopolymer” comprising substantially identical recurring units formed by, e.g., polymerizing a particular monomer. Unless otherwise specified, a polymer may also be a “copolymer” comprising two or more different recurring units formed by, e.g., copolymerizing two or more different monomers, and/or by chemically modifying one or more recurring units of a precursor polymer. The term “terpolymer” may be used herein to refer to polymers containing three or more different recurring units.

In exemplary embodiments, the polymer used to treat an aqueous stream comprises recurring units of one or more acrylamide monomers, and recurring units of one or more monomers selected from hydroxyalkylmethacrylates, allyloxyalkyldiols, allyloxyethanol, trimethylolpropane allyl ether, and 2-hydroxy ethyl acrylate.

An exemplary acrylamide monomer may be an acrylamide or substituted acrylamide, for example methacrylamide, N-methylol acrylamide, N,N-dimethylacrylamide, N-vinyl formamide, vinylhexanamide, 2-acrylamido-2-methylpropane sulfonic acid, and the like.

An exemplary hydroxyalkylmethacrylate monomer includes, for example 2-hydroxyethyl methacrylate (HEMA); 2, 3-dihydroxypropyl methacrylate (DHPM); and 3-hydroxy propyl methacrylate. In exemplary embodiments, the polymer comprises recurring units of 2-hydroxyethyl methacrylate (HEMA). In exemplary embodiments, the polymer comprises recurring units of 2, 3-dihydroxypropyl methacrylate (DHPM). In exemplary embodiments, the polymer comprises recurring units of 3-hydroxy propyl methacrylate.

An exemplary allyloxyalkyldiol monomer includes, for example, 3-allyloxy-1,2-propanediol.

In exemplary embodiments, the polymer comprises recurring units of allyloxyethanol. In exemplary embodiments, the polymer comprises recurring units of trimethylolpropane allyl ether. In exemplary embodiments, the polymer comprises recurring units of 2-hydroxy ethyl acrylate.

In exemplary embodiments, the ratio of acrylamide monomers to other monomers (hydroxyalkylmethacrylates, allyloxyalkyldiols, allyloxyethanol, trimethylolpropane allyl ether, and/or 2-hydroxy ethyl acrylate monomers) is in the range about 10:1 to about 1:10, about 5:1 to about 1:5, or about 3:1 to about 1:3.

In exemplary embodiments, the ratio of the weight percent of acrylamide monomers to the weight percent of other monomers (hydroxyalkylmethacrylates allyloxyalkyldiols, allyloxyethanol, trimethylolpropane allyl ether, and/or 2-hydroxy ethyl acrylate monomers) is in the range of about 90:10 to about 10:90; about 90:10 to about 40:60; about 90:10 to about 70:30; or about 85:15 to about 75:25.

In exemplary embodiments, the polymer is linear. In exemplary embodiments, the polymer structure may include branched polymers, star polymers, comb polymers, crosslinked polymers, or combinations thereof.

In exemplary embodiments, the polymer has an average molecular weight in the range of about 1500 to about 20000 daltons, or about 3000 to about 6000 daltons.

In exemplary embodiments, the polymer may be made in accordance with any of a variety of polymerization methods. For example, suitable methods of addition polymerization include but are not restricted to free radical polymerization, controlled radical polymerization such as atom transfer radical polymerization, reversible addition-fragmentation chain transfer, nitroxide mediated polymerization, cationic polymerization, or an ionic polymerization. In exemplary embodiments, the polymers may be made by radical or controlled radical polymerization methods. Suitable reaction media include but are not restricted to water solution, aqueous solution (comprising water and polarity changing water soluble organic compounds such as alcohols ethers, esters, ketones and or hydroxy ethers), emulsion, and microemulsion.

In exemplary embodiments, the polymers described herein can be used in methods for treatment of contaminated process waters, in particular for mining process water. In exemplary embodiments, the polymers can be used to chelate or trap contaminants, for example metals and metal compounds, in water or an aqueous stream. The solids that form from the chelation or trapping of the contaminants by the exemplary polymers facilitate efficient removal of the contaminants from the water or aqueous stream.

### Aqueous Streams

The expression “aqueous stream” as used herein refers to any aqueous liquid that contains undesirable amounts of contaminants. In exemplary embodiments, the aqueous stream comprises water and one or more contaminants, for example, metals or metalloids. Exemplary aqueous streams include but are not limited to drinking water, ground water, well water, surface water, such as waters from lakes, ponds and wetlands, agricultural waters, wastewater, such as wastewater or leaching water from mining or industrial processes, geothermal fluids, water from mining processes associated with smelting, mine dewatering, tailing impoundment treatment, chemical induced leaching, flotation, autoclave, acid mine drainage, and the like. In exemplary embodiments, the aqueous stream is an industrial stream, process stream, wastewater from flue gas desulfurization units, runoff from wet fly ash ponds, groundwater stream, and the like. In exemplary embodiments, the aqueous stream is produced from a mining process, for example a smelting process, such a smelting process gold, copper, iron, nickel, silver, phosphate, coal or molybdenum; or processes associated with mine dewatering, tailing impoundment treatment, chemical induced leaching, flotation, autoclave, acid mine drainage, and the like. The embodiments described herein may be used to reduce or remove contaminants resulting from aqueous streams from various processes, including, for example, coal mining, industrial minerals mining (e.g., phosphate, clays, white minerals, etc.), metals mining and processing (e.g., gold, copper, uranium, silver, nickel, etc.), metals smelting, municipal and industrial processes (e.g., coal burning power plants, and landfill leachate), oil processes (e.g., oil exploration, production, processing and/or refining). In exemplary embodiments, the aqueous stream comprises wastewater from a mining process, for example metal-mining process.

In exemplary embodiments, the method can be used to remove one or more contaminants from any aqueous stream containing greater than about 2.0 ppb of the one or more contaminants. In exemplary embodiments, the method is effective for treating aqueous streams containing more than 200 ppm of one or more contaminants. In an exemplary embodiment, the method is effective in decreasing levels of one or more contaminants to below about 100, about 10, about 5, or about 2 ppm. In an additional exemplary embodiment, the method is effective in decreasing levels of one or more contaminants to below about 1500, about 600, about 100, about 10, or about 2 ppb.

Various aspects of the embodiments may vary depending upon the composition of the aqueous stream, and the desired treatment result. For example, to treat a given aqueous stream, the polymer composition, proportions of the individual monomers, the sequence of adding the polymer, and optional additives may be determined to provide a desired result. Such variables would be understood by those skilled in the art, in view of the disclosure herein, and may be determined from experience with different aqueous stream compositions.

In exemplary embodiments, the pH of the aqueous stream is in an acidic pH range. For example, the pH of the aqueous stream may be less than about 4, about 5 or about 6. In exemplary embodiments, the pH of the aqueous stream is in a neutral pH range. For example, the pH of the aqueous stream is from about 6.5 to about 8, about 6.7 to about 7.5, or about 7 to 7.5. In exemplary embodiments, the pH of the aqueous stream is in a basic pH range. For example, the pH of the aqueous stream is from about 8 to about 11, about 8 to about 9, or about 8.3 to about 8.7. In exemplary embodiments, the pH is of the untreated aqueous stream. In certain embodiments, it is not necessary to adjust to pH of the aqueous stream.

In exemplary embodiments, the pH of the aqueous stream is adjusted to achieve a necessary or desired pH, for example an acidic pH, a neutral pH, or a basic pH. In exemplary embodiments, the pH of the aqueous stream is adjusted, for example, by adding any suitable reagent. In an exemplary embodiment the pH of the aqueous stream may be adjusted by adding lime, sodium sulfide, sodium hydroxide, potassium hydroxide, other caustic substances, or mixtures thereof. With knowledge of the present disclosure, one of skill in the art would understand which pH ranges would be suitable for the intended purpose and how to achieve those pH ranges.

### Contaminants

The exemplary polymers and methods may be used to reduce or remove a variety of metallic or non-metallic contaminants. As used herein, a “contaminant” refers to any substance which is not desirous, including those which may be considered harmful to humans or the environment, for example metals, non-metals, and/or oxyanions. The embodiments may remove metal or metalloid contaminants, such as zinc, copper, barium, aluminum, manganese, cobalt, iron, beryllium, sodium, magnesium, calcium, titanium, chromium, nickel, arsenic, selenium, strontium, molybdenum, silver, cadmium, tin, antimony, lead, other metal or metalloid contaminants, including the various oxidation states of these metals and metalloids, compounds comprising these metals or metalloids, and alloys comprising these metals or metalloids. In exemplary embodiments, the contaminants comprise one or more transition metal-based compounds. In exemplary embodiments, the one or more contaminants may be any of the contaminants described herein or any mixture of the contaminants.

In exemplary embodiments, the contaminant is a zinc-based contaminant, for example a compound comprising zinc or mixture thereof. Zinc is a water soluble substance that is found naturally in the environment. Elevated levels of Zn may be caused by industrial activities, such as mining, coal and waste combustion and steel processing, cause zinc to be present at toxic levels. In exemplary embodiments, the method can be used to reduce the zinc-based contaminants in an aqueous stream to below about 1000 ppm, about 100 ppm, about 10 ppm, about 1 ppm, about 500 ppb, about 200 ppb, about 150 ppb, about 100 ppb, about 70 ppb, about 50 ppb or about 10 ppb.

In exemplary embodiments, the contaminant is a copper-based contaminant, for example a compound comprising copper or mixture thereof. In exemplary embodiments the method can be used to reduce the copper-based contaminants in an aqueous stream to below about 1 ppm, about 200 ppb, about 150 ppb, about 100 ppb, about 50 ppb, about 10 ppb, about 5 ppb, or about 1 ppb.

In exemplary embodiments, the contaminant is an aluminum-based contaminant, for example a compound comprising aluminum or mixture thereof. In exemplary embodiments the method can be used to reduce the aluminum-based contaminants in an aqueous stream to below about 100 ppm, about 50 ppm, about 10 ppm, about 5 ppm, about 1.5 ppm, about 1 ppm, or about 0.5 ppm.

In exemplary embodiments, the contaminant is a manganese-based contaminant, for example a compound comprising manganese or mixture thereof. In exemplary embodiments the method can be used to reduce the manganese-based contaminants in an aqueous stream to below about 200 ppm, 150 ppm, about 100 ppm, about 50 ppm, about 20 ppm, about 10 ppm, or about 1 ppm.

In exemplary embodiments, the contaminant is an iron-based contaminant, for example a compound comprising iron or mixture thereof. In exemplary embodiments the method can be used to reduce the iron-based contaminants in an aqueous stream to below about 2000 ppb, about 1000 ppb, about 800 ppb, about 600 ppb, about 500 ppb, about 400 ppb, about 300 ppb, or about 150 ppb.

In exemplary embodiments, the contaminant is a cobalt-based contaminant, for example a compound comprising cobalt or mixture thereof. In exemplary embodiments the method can be used to reduce the cobalt-based contaminants in an aqueous stream to below about 1 ppm, about 50 ppb, about 25 ppb, about 20 ppb, about 15 ppb or about 5 ppb.

In exemplary embodiments, the contaminant is a barium-based contaminant, for example a compound comprising barium or mixture thereof. In exemplary embodiments the method can be used to reduce the barium-based contaminants in an aqueous stream to below about 1 ppm, about 100 ppb, about 75 ppb, about 50 ppb, about 40 ppb or about 30 ppb.

### Methods for Removing Contaminants

Exemplary methods for removing, or reducing the amount of, one or more types of contaminants in an aqueous stream include treating the aqueous stream with one or more of the polymers described herein to form solids of the contaminants or solidified contaminants. The methods further comprise removal of the solidified contaminants, and optionally agitation of the aqueous stream.

In exemplary embodiments, treatment of the aqueous stream includes any suitable method of combining the polymer and the aqueous stream, so that the polymer interacts with the contaminant, to facilitate or enhance removal of one or more contaminants from the aqueous stream. In exemplary methods, treatment of the aqueous stream may include adding the polymers to an aqueous stream, or by passing the aqueous stream through the polymers. In exemplary embodiments, the polymer may chelate the one or more contaminants or form solids of the contaminants. The resulting chelated contaminants, or solidified contaminants, and other amorphous solid masses or suspended solids in the aqueous stream, may be separated from the aqueous stream, such as, for example, by gravity settling, filtration or other conventional solid removal methods.

Exemplary methods can optionally include pH adjustment of the aqueous stream. Exemplary methods may include the addition of additives and/or flocculants to the treated or untreated aqueous stream.

In exemplary methods, the polymer comprises recurring units of one or more acrylamide monomers and recurring units of one or more monomers selected from hydroxyalkylmethacrylates allyloxyalkyldiols, allyloxyethanol, trimethylolpropane allyl ether, and 2-hydroxy ethyl acrylate.

In exemplary methods, treating the aqueous stream includes treatment with one polymer. In exemplary methods, treating the aqueous stream may include treatment with two or more polymers. When two or more exemplary polymers is added to the aqueous stream, the respective polymers may be added to the aqueous stream together or separately, simultaneously or sequentially. In certain embodiments, the one or more polymers may be added to the aqueous stream in one or more doses, such as, for example, in intervals, in a stepwise fashion, or in a continuous fashion.

In exemplary embodiments, the polymer may be introduced to the aqueous stream in neat form. In exemplary embodiments, the polymer is suspended or dissolved in a solvent, and the resulting solution or suspension is added to the aqueous stream. In exemplary embodiments, the polymer can be introduced as dry materials or as dispersions, for example dispersions in water.

In exemplary methods, the treatment polymer may be added to the aqueous stream in an amount sufficient to produce a desired effect or result. In exemplary embodiments, the dosage of polymers added to the aqueous stream is about 10 ppm to about 50,000 ppm, about 10 ppm to about 20,000 ppm, about 10 ppm to about 12,000 ppm, about 20 ppm to about 10,000 ppm, about 20 ppm to about 1000 ppm, about 20 ppm to about 500 ppm. In view of the teachings herein, one of skill in the art would understand how to adjust the polymer dosage to produce a desired effect or result.

In exemplary embodiments, the contaminant in the aqueous stream is a zinc-based contaminant and treatment includes adding a polymer at a dosage of from about 1 ppm to about 50,000 ppm, about 100 ppm to about 50,000 ppm, or about 6000 ppm to about 20,000 ppm. In exemplary embodiments, the contaminant is a copper-based contaminant and treatment includes a polymer dosage of from about 1 ppm to about 50,000 ppm, about 50 ppm to about 50,000 ppm, or about 500 ppm to about 5000 ppm. In exemplary embodiments, the contaminant is an iron- or aluminum-based contaminant and treatment includes a polymer dosage of from about 1 ppm to about 20,000 ppm, about 50 ppm to about 20,000 ppm, or about 50 ppm to about 1000 ppm. In exemplary embodiments, the contaminant is a manganese-based contaminant and treatment includes a polymer dosage of from about 1 ppm to about 50,000 ppm, about 50 ppm to about 50,000 ppm, or about 300 ppm to about 12,000 ppm. In exemplary embodiments, the contaminant is a cobalt-based contaminant and treatment includes a polymer dosage of from about 1 ppm to about 50,000 ppm, about 50 ppm to about 50,000 ppm, or about 300 ppm to about 12,000 ppm. In exemplary embodiments, the contaminant is a barium-based contaminant and treatment includes a polymer dosage of from about 1 ppm to about 50,000 ppm, about 50 ppm to about 50,000 ppm, or about 300 ppm to about 12,000 ppm. In exemplary embodiments, the dosage of the polymer used in the method is approximately stoichiometric with the amount of contaminant to be treated in the aqueous stream.

In an exemplary method, the treatment includes adding the polymer to the aqueous stream in an amount necessary to reduce the concentration of the one or more contaminants to below about 100 ppb, about 50 ppb, about 40 ppb, about 30 ppb, about 20 ppb, about 10 ppb, about 5 ppb, about 4 ppb, about 3 ppb, about 2 ppb, about 1 ppb, about 0.5 ppb, about 0.4 ppb, about 0.3 ppb, about 0.25 ppb, about 0.2 ppb, about 0.15 ppb, or about 0.1 ppb, in total or per species.

In exemplary embodiments, the method also may include adding one or more additives to the aqueous stream. Exemplary additives include but are not limited to aluminum-containing minerals or clays, or iron-containing minerals or clays, such as kaolinate, aluminate, ferrohydrate, hematite, bentonite, and the like. The additives may be added to the aqueous streams before, during or after addition of the polymer. The additive may be added to the aqueous stream in an amount of about 0.1% to about 50%, about 0.1% to about 40%, about 0.1% to about 30%, about 0.1% to about 20%, about 0.1% to about 10%, by weight of the exemplary polymer.

In an exemplary embodiment, polymers, and optionally other additives, are mixed in water and allowed to settle. The resulting solid can be processed, for example milled, into a controlled particle size, for example about 200 to about 1000 micron. These solid particles can be applied as a filter media wherein the aqueous stream containing contaminants is run through the bottom of the filter media, through the top of the filter media, or into a closed circuit.

In exemplary methods, treating the aqueous stream may occur in a separate step or process. In exemplary methods, treating the aqueous stream may occur while the stream is in transit between steps or processes. In exemplary methods, treating the aqueous stream may occur in combination with another step or process. In exemplary embodiments, treating the aqueous stream may be batch process, a continuous process or a semicontinuous process. Such processes can include settling or filtering processes.

In exemplary embodiments, treating the aqueous stream includes adding the polymer and the aqueous stream to a reactor or mixing tank. The polymer and the aqueous stream may be stirred or agitated in the reactor or tank. In one embodiment, the aqueous stream and the polymer may be stirred or agitated for a period of time from about 5 minutes to about 12 hours, or about 1 hour to about 3 hours. In exemplary embodiments, the aqueous stream and the polymer may be stirred for at least about 15 minutes, about 30 minutes, about one hour, about two hours, or about 3 hours. There is no particular limit on the amount of time that the aqueous stream and the polymer may be stirred.

In exemplary embodiments, the aqueous stream and polymer may be allowed to settle. In exemplary embodiments, the aqueous stream and polymer may be transferred to a thickener or settling tank, or may be allowed to settle where it is. In certain embodiments, a flocculant may be added to the aqueous stream to assist in settling.

In exemplary embodiments, the method may further include adding one or more flocculants. Any suitable flocculant or mixture of flocculants may be used in the exemplary methods. In certain embodiments, the one or more flocculants include a polymer flocculant. Any polymer flocculants known in the art may be used in the processes described herein. An exemplary polymer flocculant may be anionic, nonionic, or cationic. Nonlimiting examples of exemplary polymer flocculants include, for example, flocculant-grade homopolymers, copolymers, and terpolymers prepared from monomers such as (meth)acrylic acid, (meth)acrylamide, 2-acrylamido-2-methylpropane sulfonic acid, and ethylene oxide. An exemplary flocculant is an acrylamide-based flocculant.

In the exemplary embodiments, the one or more flocculants can be added to the aqueous stream in any dosage that will achieve a necessary or desired result. In one embodiment, the dosage of the one or more flocculants is about 5 ppm to about 100 ppm; about 10 ppm to about 70 ppm; or about 20 ppm to about 50 ppm. In one embodiment, the dosage of the one or more flocculants is less than about 100 ppm, about 70 ppm, or about 50 ppm.

In exemplary embodiments, the method may further include adding to the aqueous stream one or more absorbents and/or one or more coagulants.

In an exemplary embodiment, the method further includes adding one or more absorbents before the addition of the one or more flocculants. An “absorbent” as referred to herein includes silica-based compounds, for example an inorganic silica-based polymer, a clay-based material, cellulose, alumina-cased adsorbents, ferrohydrate adsorbents, carbon, for example carbon black, or a mixture thereof.

In exemplary embodiments, the one or more absorbents can be added to the aqueous stream in any dosage that will achieve a necessary or desired result. In one embodiment, the dosage of the one or more absorbents is about 1 to about 10,000 ppm; about 50 to about 5000 ppm; or about 100 to about 1000 ppm. In one embodiment, the dosage of the one or more absorbents is less than about 10,000 ppm, about 5000 ppm, or about 1000 ppm.

In an exemplary embodiment, the method includes adding one or more coagulants before the addition of the one or more flocculants. A “coagulant” as referred to herein includes iron compounds or salts, for example ferric or ferrous compounds or salts; aluminum compounds or salts; hydrated lime; magnesium carbonate; a polymer that contains one or more quaternized ammonium groups or mixtures thereof. Iron coagulants include, for example, ferric sulfate, ferrous sulfate, ferric chloride and ferric chloride sulfate. Aluminum coagulants include, for example, aluminum sulfate, aluminum chloride and sodium aluminate. Polymer coagulants that contain one or more quaternized ammonium groups include, for example acryloyloxyethyltrimethylammonium chloride, methacryloyloxyethyltrimethylammonium chloride, methacrylamidopropyltrimethylammonium chloride, and acrylamidopropyltrimethylammonium chloride.

In the exemplary embodiments, the one or more coagulants can be added to the aqueous stream in any dosage that will achieve a necessary or desired result. In one embodiment, the dosage of the one or more coagulants is about 1 to about 15 times the amount of the contaminants by mass (e.g. Fe:As mass ratio). In one embodiment, the dosage of the one or more coagulants is less than about 15 times the amount of the contaminants by mass.

According to the embodiments, the treated aqueous stream includes solidified contaminants that may then be recovered and removed. In exemplary embodiments, the method includes separating the solidified contaminants from the aqueous stream. Separating the solidified contaminants include the use of any suitable method known in the art. In exemplary embodiments, the step of separating the solidified contaminants from the aqueous stream may include gravity settling, centrifuges, hydrocyclones, decantation, filtration, thickening, another mechanical separation method, or any combination thereof. One skilled in the art will understand various methods that may be used to separate the solidified contaminants of the exemplary methods.

In exemplary embodiments, the separated contaminants may be handled or processed in any manner as necessary or desired. In one embodiment, the contaminants should be handled in compliance with governmental regulations. In some embodiments, the contaminants may be disposed of, sent to a landfill, or when solids are a concentrated source of minerals, the solids may be used a raw materials or feed to produce compounds for commercial products.

In exemplary embodiments, the methods described herein can be used to provide an economical and versatile solution for treatment of contaminated industrial or mining process waters within an operational and environmental friendly process. In exemplary embodiments, the methods may be used to remove contaminants in non-ferrous metal processes, such as mining and smelting of non-ferrous metals, for example zinc production; iron and/or steel production; fuel combustion, such as coal, oil or wood; cement manufacturing; phosphate fertilizer manufacture; or sewage sludge incineration.

In an exemplary embodiment, the method can be easily incorporated into common water treatment practices in the form of in-line addition.

The following examples are presented for illustrative purposes only, and are not intended to be limiting.

### EXAMPLES

### Example 1. General Synthesis of Exemplary Polymers

Exemplary polymers comprising recurring units of one or more acrylamide monomers and recurring units of one or more monomers selected from hydroxyalkylmethacrylates allyloxyalkyldiols, allyloxyethanol, trimethylolpropane allyl ether, and 2-hydroxy ethyl acrylate can be prepared by the following general synthesis.

Three feed tanks were prepared with the following compositions:
Tank 1—acrylamide monomers, monomers of hydroxyalkylmethacrylates allyloxyalkyldiols, allyloxyethanol, trimethylolpropane allyl ether, and 2-hydroxy ethyl acrylate.
Tank 2—water and sodium persulfate
Tank 3—sodium bisulfite solution (e.g. 40% solution)

The contents of tanks 1, 2 and 3 were charged into a reactor containing water. The contents of the tanks were charged into the reactor over a period of time, which varied depending on the polymer to be formed. An exemplary period of time for this addition was about 4 hours. All tanks and reactors were maintained under a substantially inert atmosphere (e.g. nitrogen atmosphere). The reactor contents were maintained at an appropriate temperature to facilitate polymerization, for example about 90° C., and the contents were stirred or agitated during the additions from the tanks Once the contents of the tanks were charged to the reactor, the tanks and tank lines were flushed with a small amount of water into the reactor. The reactor, once it contains the full contents of the tanks, was held the polymerization temperature, for example 90° C., and stirred for a further period of time, for example one hour, to allow the reaction to proceed to completion. The reaction mixture was subsequently be allowed to cool, for example to 30° C. or ambient temperature. In certain preparations, the pH of the reaction mixture was adjusted (e.g. by addition of caustic.) The polymer was isolated from the solution for use in the methods described herein.

### Example 2. Treatment of Raw Waste Water with Exemplary Polymers

10 ppm of a 50 wt % solution of an exemplary polymer, chelant or flocculant was added to 200 mL of the raw waste water. The raw untreated waste water was obtained from a mine that mines and processes an industrial mineral. The water and exemplary polymer, chelant or flocculant were agitated for a period of time, for example about 1 minute to about 20 minutes. The mixture was subsequently allowed to settle for a period of time, for example 10 minutes. The mixture was filtered through a 0.45 micron Millipore filter and the supernatant was analyzed for the identity and concentration of metal contaminants by an Inductively Coupled Plasma Mass Spectrometer (ICP-MS).

The ICP-MS used in these experiments was an Agilent 7700x equipped with a He collision cell to remove polyatomic isobaric interferences. All samples were digested according to EPA 200.8 protocol adapted for environmental express digesters. The samples were concentrated 5 times during the digestion and reconstituted to their original concentration with 5% nitric acid. Samples were introduced to the nebulizer spray chamber by an ASX-500 series autosampler. The average of six replicate measurements were recorded. The samples were compared to Sc, Y, and Tb for precision.

The results of the treatment of the water samples are shown in Table 1.

The exemplary polymers used in these experiments included Acrylamide hydroxyethyl methacrylate chelant (AMD/HEMA) and Acrylamide 3-allyloxy-1,2-propanediol chelant (AMD/ALLYL). The composition of the polymers was about 18:82 ALLYL or HEMA to AMD by weight. The commercially available chelant used for comparison was sodium dimethyldithiocarbamate. The flocculant used was a commercially available acrylamide flocculant.

TABLE 1
Water Chemical Analysis

| | Treatment | | | | |
|---|---|---|---|---|---|
| | none | | | | |
| | (raw | | | | |
| | waste | | | AMD/ | AMD/ |
| | water) | chelant | flocculant | HEMA | ALLYL |
| pH | 3.2 | 3.73 | 2.85 | 3.03 | 3.47 |
| Zn (ppb) | 296.5 | 152.7 | 424.5 | 149.9 | 163.1 |
| Cu (ppb) | 172.4 | 9.5 | 168.1 | 129.4 | 129.6 |
| Ba (ppb) | 226.4 | 71.5 | 48.5 | 65.9 | 66.0 |
| turbidity | 4760 | 1.0 | 0.41 | 0.8 | 1.0 |
| dissolved | 972 | 970 | 913 | 1568 | 1056 |
| solids | | | | | |
| mg/L | | | | | |
| hardness | 94.0 | 91.7 | 91.1 | 88.5 | 86.5 |
| (ppm) | | | | | |
| total | 2.116 | 17.3 | 16 | 31.3 | 28.0 |
| suspended | | | | | |
| solids (ppm) | | | | | |
| Fluoride | 1.9 | ND | ND | ND | ND |
| (ppm) | | | | | |
| Chloride | 10.4 | 8.4 | 10 | 9.3 | 8.1 |
| (ppm) | | | | | |
| Sulfate | 845.5 | 694.9 | 650.2 | 655.4 | 667.3 |
| (ppm) | | | | | |
| Nitrate | ND | 25.7 | 6.5 | 173.9 | 30.3 |
| (ppm) | | | | | |
| Phosphate | ND | ND | 16.2 | ND | ND |
| (ppm) | | | | | |

### Example 3. Treatment of raw waste water with exemplary polymers with pH adjustment

10 ml of a 50 wt % solution of an exemplary polymer, chelant or flocculant was added to 200 ml, of the raw waste water. The raw untreated waste water was obtained from a mine that mines and processes an industrial mineral. The water and exemplary polymer, chelant or flocculant were agitated for a period of times, for example 5 to about 20 minutes. The pH of the sample was adjusted to about 7 by adding caustic prior to the addition of the chelant. The mixture was subsequently allowed to settle for a period of time, for example about 10 minutes. The mixture was filtered and the supernatant was analyzed for the identity and concentration of metal contaminants by Inductively Coupled Plasma Mass Spectrometer (ICP-MS).

The ICP-MS used in these experiments was an Agilent 7700x equipped with a He collision cell to remove polyatomic isobaric interferences. All samples were digested according to EPA 200.8 protocol adapted for environmental express digesters. The samples were concentrated 5 times during the digestion and reconstituted to their original concentration with 5% nitric acid. Samples were introduced to the nebulizer spray chamber by an ASX-500 series autosampler. The average of six replicate measurements were recorded. The samples were compared to Sc, Y, and Tb for precision.

The results of the treatment and pH adjustment of the water samples are shown in Table 2.

The exemplary polymers used in these experiments included Acrylamide hydroxyethyl methacrylate chelant (AMD/HEMA) and Acrylamide 3-allyloxy-1,2-propanediol chelant (AMD/ALLYL). The composition of the polymers was about 18:82 ALLYL or HEMA to AMD by weight. The commercially available chelant used for comparison was sodium dimethyldithiocarbamate. The flocculant used was a commercially available acrylamide flocculant.

TABLE 2
Waste Water Analysis

| | Treatment | | | | |
|---|---|---|---|---|---|
| | none (raw | | | | |
| | waste | | | AMD/ | AMD/ |
| | water) | chelant | flocculant | HEMA | ALLYL |
| pH | 3.2 | 7.25 | 2.85 | 7.77 | 6.31 |
| turbidity | 4760 | 0.8 | 0.41 | 1.0 | 1.0 |
| dissolved | 972 | 878 | 913 | 901 | 876 |
| solids | | | | | |
| mg/L | | | | | |
| hardness | 94.0 | 87.0 | 91.1 | 87.4 | 86.3 |
| ppm | | | | | |
| total | 2.116 | 24 | 16 | 28.0 | 32.7 |
| suspended | | | | | |
| solids (ppm) | | | | | |
| Zn (ppb) | 296.5 | ND | 424.5 | ND | ND |
| Cu (ppb) | 172.4 | 2.9 | 168.1 | 12.4 | 13.4 |
| Al (ppb) | 166060.1 | 1521.4 | 4274.6 | 1449.6 | 1330.2 |
| Mn (ppb) | 260.7 | 136.9 | 253.9 | 137.8 | 137.2 |
| Fe (ppb) | 5530.8 | 503.1 | 773.6 | 581.8 | 516.1 |
| Co (ppb) | 34.4 | 21.7 | 23.0 | 12.2 | 11.5 |
| Ba (ppb) | 226.4 | 30.2 | 48.5 | 26.3 | 26.5 |
| Fluoride | 1.9 | ND | ND | ND | ND |
| (ppm) | | | | | |
| Chloride | 10.4 | 9.8 | 10 | 9.1 | 8.6 |
| (ppm) | | | | | |
| Sulfate | 845.5 | 699.2 | 650.2 | 671.3 | 693.0 |
| (ppm) | | | | | |
| Nitrate | ND | 21.2 | 6.5 | 40.7 | 25.5 |
| (ppm) | | | | | |
| Phosphate | ND | ND | 16.2 | ND | ND |
| (ppm) | | | | | |

In the preceding specification, various embodiments have been described with reference to the examples. It will, however, be evident that various modifications and changes may be made thereto, and additional embodiments may be implemented, without departing from the broader scope of the exemplary embodiments as set forth in the claims that follow. The specification and drawings are accordingly to be regarded in an illustrative rather than restrictive sense.

We claim:

1. A method for removing one or more contaminants from an aqueous stream comprising: adding a polymer comprising recurring units of one or more acrylamide monomers and recurring units of one or more monomers selected from hydroxyalkylmethacrylates allyloxyalkyldiols, allyloxyethanol, trimethylolpropane allyl ether, and 2-hydroxy ethyl acrylate to the aqueous stream to form solidified contaminants; and separating the solidified contaminants from the aqueous stream.

2. The method of claim 1, wherein the method further comprises the step of agitating the aqueous stream after the polymer has been added.

3. The method of claim 1, wherein the one or more acrylamide monomers is selected from acrylamide and substituted acrylamides, for example methacrylamide, N-methylol acrylamide, N,N-dimethylacrylamide, N-vinyl formamide, vinylhexanamide, and 2-acrylamido-2-methylpropane sulfonic acid.

4. The method of claim 1, wherein the polymer comprises recurring units of one or more monomers selected from hydroxyalkylmethacrylates.

5. The method of claim 4, wherein the hydroxyalkylmethacrylate is 2-hydroxyethyl methacrylate.

6. The method of claim 1, wherein the polymer comprises recurring units of one or more monomers selected from allyloxyalkyldiols.

7. The method of claim 6, wherein the allyloxyalkyldiol is 3-allyloxy-1,2-propanediol.

8. The method of claim 1, wherein the polymer comprises recurring units of allyloxyethanol monomers.

9. The method of claim 1, wherein the polymer comprises recurring units of trimethylolpropane allyl ether monomers.

10. The method of claim 1, wherein the polymer comprises recurring units of 2-hydroxy ethyl acrylate monomers.

11. The method of claim 1, wherein the polymer comprises recurring units of one or more acrylamide monomers and recurring units of one or more monomers selected from hydroxyalkylmethacrylates allyloxyalkyldiols, allyloxyethanol, trimethylolpropane allyl ether, and 2-hydroxy ethyl acrylate wherein the ratio of the weight percent of acrylamide monomers to the weight percent of hydroxyalkylmethacrylates allyloxyalkyldiols, allyloxyethanol, trimethylolpropane allyl ether, and/or 2-hydroxy ethyl acrylate monomers is in the range of about 90:10 to about 70:30.

12. The method of claim 1, wherein the one or more contaminants is selected from the group consisting of zinc, copper, barium, aluminum, manganese, cobalt, iron, beryllium, sodium, magnesium, calcium, titanium, chromium, nickel, arsenic, selenium, strontium, molybdenum, silver, cadmium, tin, antimony, lead, other metal or metalloid contaminants, including the various oxidation states of these metals and metalloids, compounds comprising these metals or metalloids, and alloys comprising these metals or metalloids.

13. The method of claim 1, wherein the step of separating the solidified contaminants from the aqueous stream is by gravity settling, centrifuges, hydrocyclones, decantation, filtration, thickening or another mechanical separation method.

14. The method of claim 1, wherein the one or contaminants are zinc-based contaminants and method the reduces the zinc-based contaminants in an aqueous stream to below about 200 ppb.

15. The method of claim 1, wherein the one or contaminants are copper-based contaminants and method the reduces the copper-based contaminants in an aqueous stream to below about 150 ppb.

16. The method of claim 1, wherein the one or contaminants are aluminum-based contaminants and method the reduces the aluminum-based contaminants in an aqueous stream to below about 1.5 ppm.

17. The method of claim 1, wherein the one or contaminants are iron-based contaminants and method the reduces the iron-based contaminants in an aqueous stream to below about 600 ppb.

18. The method of claim 1, wherein the one or contaminants are cobalt-based contaminants and method the reduces the cobalt-based contaminants in an aqueous stream to below about 20 ppb.

19. The method of claim 1, wherein the one or contaminants are barium-based contaminants and method the reduces the barium-based contaminants in an aqueous stream to below about 50 ppb.
